(19) United States
(12) Patent Application Publication
(10) Pub. No.: US 2026/0099812 A1
(43) Pub. Date: Apr. 9, 2026

(54) DETERMINATION OF A PART INVENTORY SAFETY FACTOR

(71) Applicant: ELECTRICAL COMPONENTS INTERNATIONAL, INC., St. Louis, MO (US)

(72) Inventor: Armando Robles, Southfield, MI (US)

(21) Appl. No.: 19/351,590

(22) Filed: Oct. 7, 2025

Related U.S. Application Data
(60) Provisional application No. 63/704,419, filed on Oct. 7, 2024.

(51) Int. Cl. G06Q 10/0875; G06Q 10/087

(52) U.S. Cl. CPC G06Q 10/0875; G06Q 10/08772

(57) ABSTRACT

An apparatus includes at least one processor and at least one memory in electronic communication with at least one processor. The at least one memory has instruction stored thereon which when executed by the at least one processor direct the at least one processor to communicate to a communication device of at least one user to display a minimum safety factor of parts on hand which is determined based upon a usage of each of a plurality of parts within a predetermined period of time. A display device is communicated to to provide the minimum safety factor on the display device. A factory and a method are also disclosed.

### CROSS-REFERENCE TO RELATED APPLICATIONS

This application claims priority to U.S. Provisional Application No. 63/704,429, which was filed on Oct. 7, 2024, and is incorporated herein by reference.

### BACKGROUND

This application relates to a method and apparatus for determining a minimum safety factor for on hand part inventory numbers.

Modern factory environments use a plurality of parts that must be kept on hand to make various components. It becomes important to ensure that there are adequate parts to form the expected number of components to be formed within a period of time.

Prior art inventory control systems essentially err on the side of ensuring there will not be a part shortage, which often results in excess inventory.

### SUMMARY

An apparatus includes at least one processor and at least one memory in electronic communication with at least one processor. The at least one memory has instruction stored thereon which when executed by the at least one processor direct the at least one processor to communicate to a communication device of at least one user to display a minimum safety factor of parts on hand which is determined based upon a usage of each of a plurality of parts within a predetermined period of time. A display device is communicated to provide the minimum safety factor on the display device

These and other features will be best understood from the following drawings and specification, the following is a brief description.

### BRIEF DESCRIPTION OF THE DRAWINGS

FIG. 1A schematically shows a factory environment.

FIG. 1B shows a simplified algorithm according to this disclosure.

FIG. 2A shows a more detailed graphical user display.

FIG. 2B shows another display option according to this disclosure.

FIG. 2C shows another display option.

FIG. 3 shows yet another option display.

FIG. 4 shows yet another option display.

FIG. 5 shows yet another display option.

FIG. 6 shows a breakdown of excess inventory based upon a class ranking of a part's value.

FIG. 7 shows raw data for determining an average daily using of each part.

FIG. 8 shows a normalized average daily usage.

FIG. 9 shows a development of the safety numbers such as utilized in FIGS. 1B and 2A.

FIG. 10 schematically shows a marketplace system interacting with data from several factories owned by a company and suppliers that are external to the company.

FIG. 11 illustrates an example user interface of the management system that corresponds to a selection of the sell tab.

FIG. 12 illustrates a second example user interface of the management system that corresponds to a selection of the buy tab.

FIG. 13 illustrates a method of managing inventory between facilities of a business.

### DETAILED DESCRIPTION

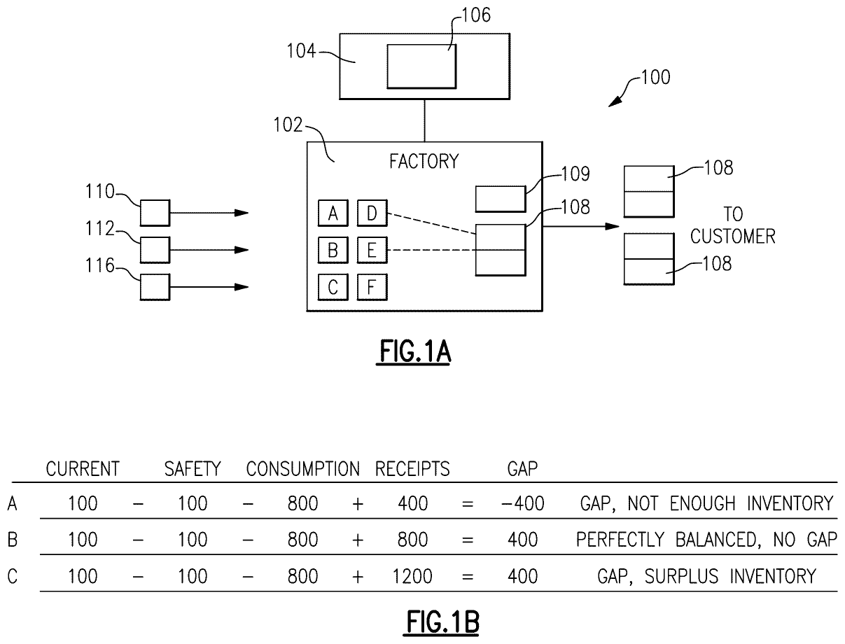

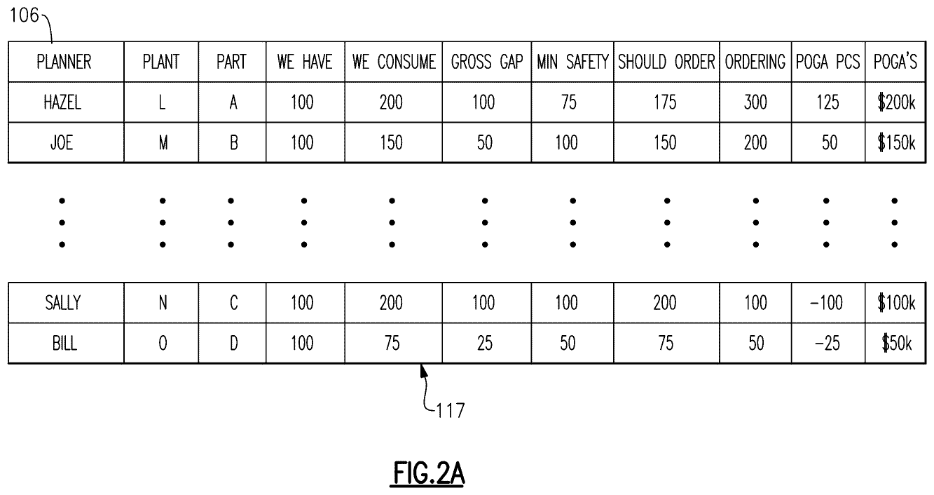

FIG. 1A shows a factory 100 in a schematic manner. A factory building 102 houses a plurality of distinct parts A, B, C, D, E, F. The factory has a particular number of on hand inventory for each of the parts A-F. Of course in practice, an actual factory may have hundreds if not thousands of distinct parts.

In the course of business a user, known as a planner for purposes of this application, will order more parts 110, 112 and 116 to supplement the on hand inventory. Meanwhile the parts are utilized to prepare components 108, using a machine 109. In the example of FIG. 1A, parts D and E are combined to form a component 108. The components 108 are then shipped to customers.

A computer 104 may control the inventory, and provide information to the planner for ordering parts to keep the on hand inventor optimum. This application relates to a method and apparatus to provide optimum inventory of on hand parts. A display, or graphical user interface 106, will supply information to the planner.

The control 104 may include one or more computer processors, memory, storage means, network devices, input and/or output devices, and/or interfaces. The control may be operable to execute one or more software programs. The control is operable to communicate with one or more networks established by one or more computing devices. The memory may include UVPROM, EEPROM, FLASH, RAM, ROM, DVD, CD, a hard drive, or other computer readable medium which may store data and/or the functionality of this description. The control 104 may be a desktop computer, laptop computer, smart phone, tablet, or any other computer device. Input devices may include a keyboard, mouse, touchscreen, etc. The output devices may include a monitor, speakers, printers, etc. Control 104 may include one or more processors coupled to memory. The control 104 may be coupled to each other by one or more connections. The connection may be a wired and/or wireless connection. The connection may be established over one or more networks and/or other computing systems. In particular the control 44 communicates with the manufacturing machines.

FIG. 1B shows an algorithm that is utilized within the computer 104 to provide optimum information to the planner. Parts A, B and C are illustrated along with current on hand inventory, a safety inventory quantity, an expected consumption number, which would be the number of parts to form components in a first period of time. Further, receipts are shown, which are parts being ordered to arrive within the first period of time. A gap is then calculated. In practice all parts used in the factory 100 will be used.

The gap is generally the sum of (safety on hand inventory+expected consumption) subtracted from the sum of the (current on hand inventory+the ordered receipts 110/112/116). A gap is then determined.

As shown in FIG. 1B, the gap for part A is negative meaning there is not sufficient inventory and additional parts should be ordered within the receipt column. Part B is perfectly balanced, with no gap. This is optimum. Part C shows a surplus of inventory. The insufficient inventory for part A poses a potential problem to ongoing manufacture of components. The surplus inventory for part C is an undesirable use of money that is simply sitting unused.

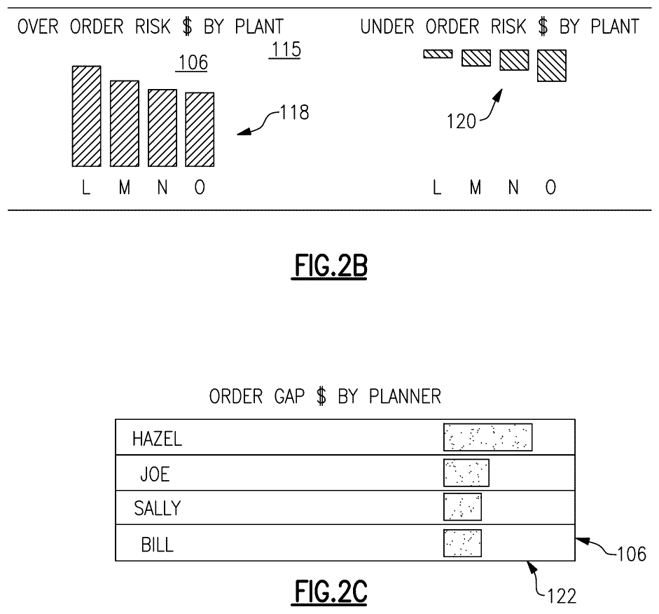

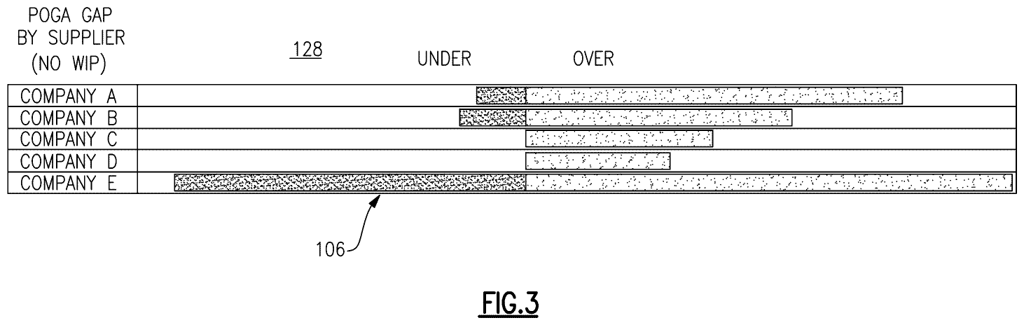

FIG. 2A shows graphical interface 106 having a first display 117. Display 117 lists a number of parts A-D with planners, Hazel, Joe, Sally, Bill along with the plants L-O. Again, all parts would be included. The “we have” column is on hand inventory. The “we consume” column is the expected consumption. The “gross gap” is the difference between on hand inventory and expected consumption. The “min safety” is the safety on hand inventory as mentioned above. The algorithm to determine this number is disclosed below. The “should order” shows the amount of the part that should be ordered to reach the perfect balance of part B in FIG. 1B. The “ordering” is the actual amount ordered.

The acronym POGA is developed here for “Planned Order Gap Analysis.” The “POGA PCS” is the amount of parts that are either unordered or overordered. Finally the “POGA $” is the amount of dollars that are being tied up by overordering. Further, the underordered parts would also be displayed, however, the dollar value is not as important as the overordered value. Note that the overordered numbers are listed from highest to lowest.

This display will provide the planner with feedback on when to scale back ordered parts, and even approach suppliers to ask that previously ordered parts be reduced.

FIG. 2B is a display 115 of overorders by plant L-O 118 and underorders by plant L-O 120. Note this breaks down the overorder and underorder risk dollars by each of a plurality of plants. Many prior art inventory controls may provide feedback on over/under ordered dollars combined per plant or supplier. However, those have typically been a difference between the two which is of less value than knowing how much overordered and underordered dollar values exist.

FIG. 2C is a display 122 of an order gap by dollars for each of a plurality of planners.

FIG. 3 shows a display 128 with overorders and underorders for each of a plurality of suppliers companies A-E. Again, providing both sides is giving the planners better information of when to order more parts and when to scale back other part orders.

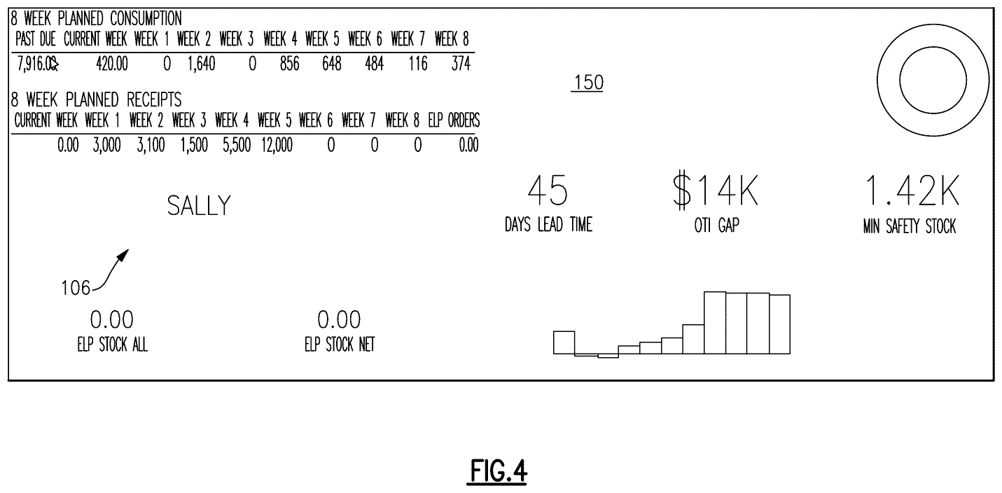

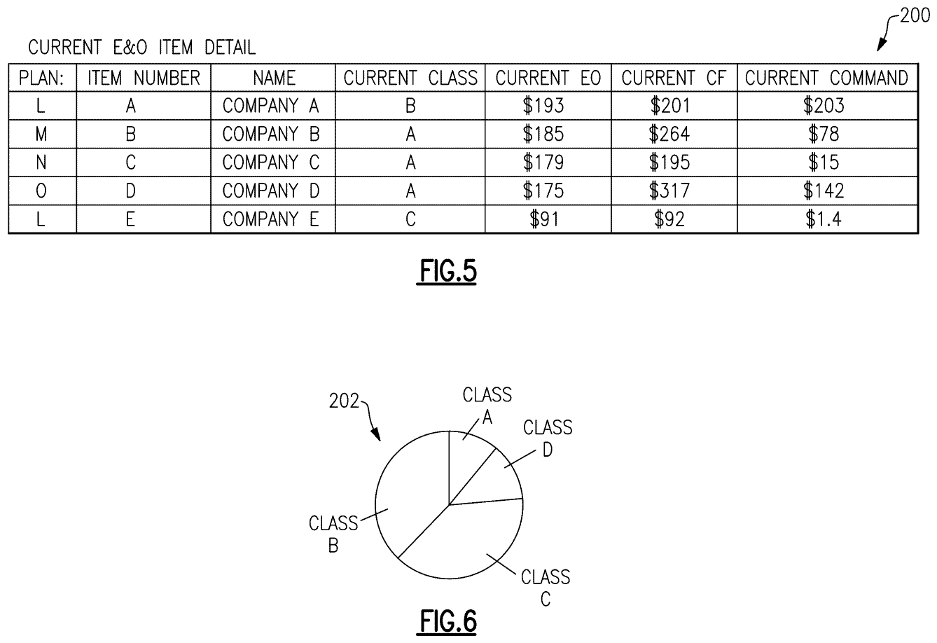

FIG. 4 shows information for a particular part on a display 150. The planner's name is displayed along with a day's lead time, a minimum safety stock number and a gap from what should be on hand to what is being ordered.

Common inventory management calculations are designed to ensure that there would be no shortages, but this tends towards resulting in excess inventory. Applicant has developed a system and process considering each item's true demand. Various variables such as minimum order quantity, standard pack, transit time and others are utilized to calculate an optimum stock level. This tool can be deployed as a diagnostic for chronic inventory shortages or excess on specific parts.

The aspects to this point are disclosed in co-pending U.S. Provisional Patent Application No. ______, filed on even date herewith entitled “METHOD AND APPARATUS FOR MONITORING ORDERED PART INVENTORY” owned by the Applicant here.

The minimum safety values as mentioned are essentially a weekly average (say 5 days) of a quantity known as ADU, or average daily usage discussed below.

FIG. 5 shows a display 200 showing E and O details, or excess and obsolete items. Thus, five parts A-E are shown for plants L, M, N and O. Supplier companies A-E are also shown associated with the parts. A current class is identified for each part between class A, class B and class C. Current inventory is compared to a current EO, which is essentially the dollar value of excess inventory as described earlier. The current inventory is subtracted from a current demand to get to the current EO number.

The class of each part is determined based upon the expense of the part and the volume usage. High price/high volume parts are considered class A parts. They will be ordered more frequently, to minimize the need to have excess inventory as they tie up a larger volume of money. Class C parts have low usage and are low price. They will be ordered less frequently. Parts in between are considered class B parts.

As an example, some threshold percentage of parts are selected to be class A, class B and class C. In general, there will be more class A parts, an intermediate number of class B parts, and a lower number of class C parts. As an example, class A parts may be delivered weekly, class B parts bi-weekly, and class C parts monthly. The safety stock for the parts will tend to be higher for class C parts, and lower for class A parts, with class B parts being in between.

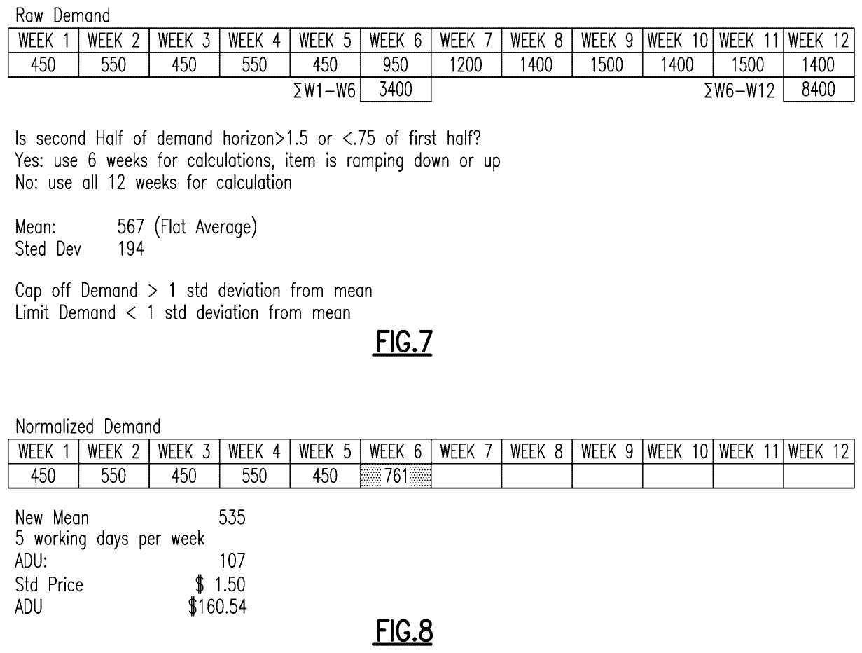

Example E & 0 dollars are shown by class and percentage in FIG. 6.

The safety numbers are determined utilizing the average daily usage numbers, as explained below, in combination with standard deviation of the actual usage over a period of time.

FIG. 7 shows a raw demand of actual usage over a 12 week period. The program asks whether the second half of the demand horizon is greater than X or less than Y of a first half demand. If the answer to this question is yes, then only the first six weeks would be utilized, as the item is ramping down or up.

When there is substantial change using only the first half improves accuracy. Since the goal is to have the optimal level now, demand near now weighs more than demand later. IF demand later is vastly different from demand near, this is an indication the part is undergoing increasing or decreasing demand. The optimal level of demand is more valuable this way. See the following examples:

If demand is 5, 5, 5, 10, 10, 10 . . . the normal average is 7.5 . . . we would have too much for 3 weeks.

If demand is 10, 10, 10, 5, 5, 5 . . . the normal average is 7.5 . . . we would have shortages for 3 weeks.

If demand is 10, 5, 10, 5, 10, 5, 10 . . . then 7.5 is perfect, but here X=Y.

A mean of the total demand per week is taken and a standard deviation is identified.

The normalized demand is shown in FIG. 8. When the answer to the question mentioned above is yes, a new mean of 535 would be used. The average daily usage would then be 107 parts based upon a five day work week. This number is utilized as the safety number.

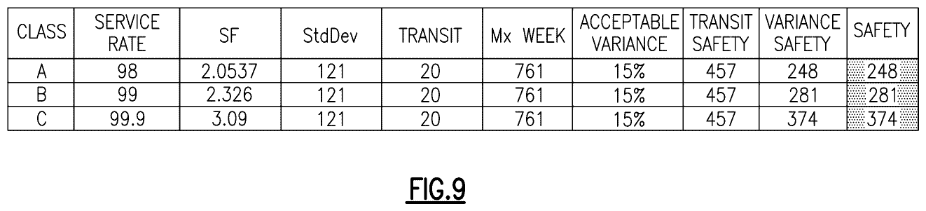

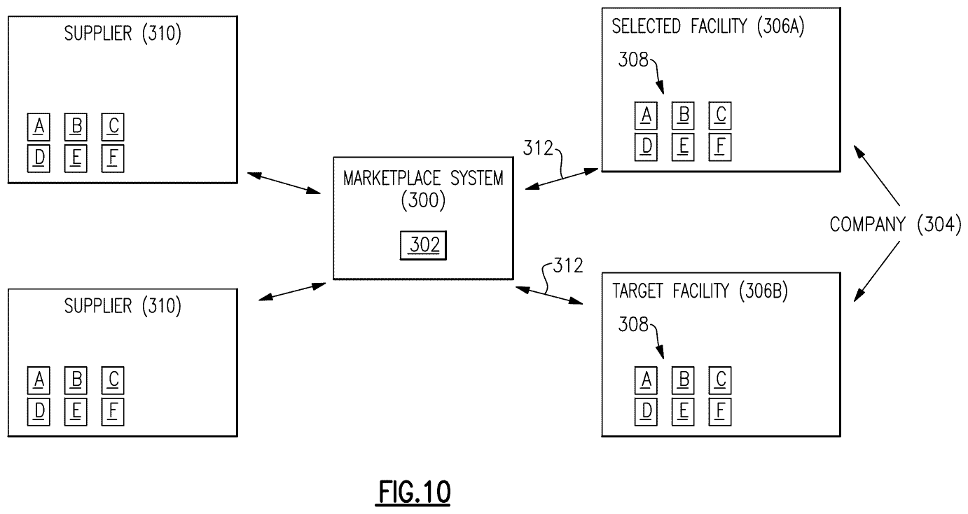

FIG. 9 shows examples of class A, B and C parts. It also shows the impact of transit time, the identification of an acceptable variance, a transit safety and variance safety.

While the safety numbers can be determined as set forth above, in a more refined embodiment illustrated in FIG. 9, a transit safety number and a variance safety number are both determined in combination with the factors mentioned above. The transit safety number may be based upon the distance to the particular supplier. The variance safety number may be selected based upon the variance in demand. The final safety number may be the lesser of the transit and variance safety numbers.

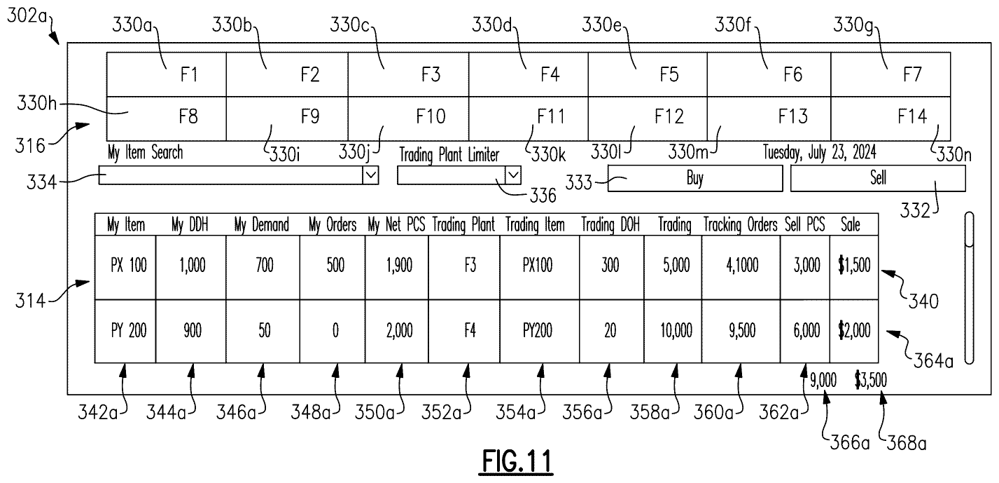

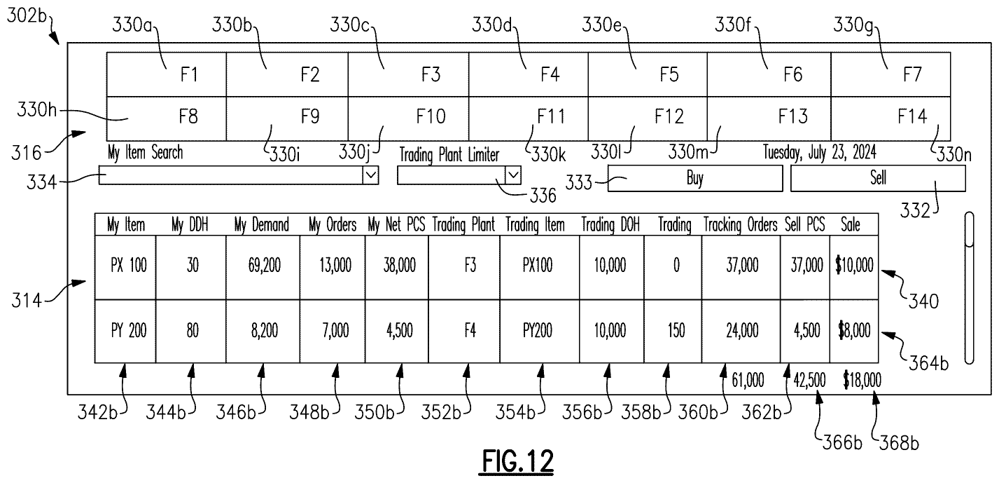

FIG. 10 shows a marketplace system 300. FIG. 11 and FIG. 12 show a user interface 302 of the marketplace system 300 that assists a company 304 having multiple facilities 306 at different site locations manage inventory 308 of distinct parts A, B, C, D, E, F. Marketplace system 300 performs a method that utilizes the surplus inventory 308 for parts A-F at the facilities 306 as determined based upon the disclosure to this point.

This disclosure develops a redistribution plan by matching a selected facility 306A with a trading facility 306B that can purchase surplus inventory 308 of the selected facility 306A or sell its own surplus inventory 308 to the selected facility 306A.

Further, the marketplace system 300 uses a cost analysis to evaluate whether redistributing the parts A-F between the facilities 306 is more cost-effective than each for each facility 306 to order parts from a supplier 310 that is external to the company 6.

Essentially, in the prior art one facility 306 may have insufficient inventory 308 and be planning to order additional inventory 308 from a supplier 310. At the same time, another facility 306 may have a surplus of that part A-F so ordering more parts A-F from a supplier 310 external to the company 304 would be wasteful.

Each facility 306 has a particular number of on hand inventory 308 for each of the parts A-F. Of course, in practice, an actual facility 306 may have hundreds if not thousands of distinct parts A-F. In the course of business, a user will manage inventory 308 and order more parts A-F to supplement the on-hand inventory 308 of parts A-F. Meanwhile the on-hand parts A-F are utilized to prepare components.

The selected facility 306A in FIG. 10 has a surplus of part A and a shortage of part B. Meanwhile the trading facility 306B has a shortage of part A and surplus of part B. The marketplace system 300 identifies the surplus and shortage of parts A and B at facilities 306A and 306B. Further, the marketplace system 300 determines whether it is cost effective for the selected facility 306A to sell its surplus inventory of part A to the target facility 306B or for the target facility 306B to order additional units of part B from the supplier 310. If the redistribution of part A from selected facility 306A to the target facility 306B, or the redistribution of part B from the target facility 306B to the selected facility 306A is cost effective, then the marketplace system 300 will propose shipping the parts A-B between the facilities 306A and 306B accordingly. Factors such as distance, shipping costs, etc. are used to determine feasibility compared to the cost of buying from a supplier.

Planners at each facility 306 of the company 304 are responsible for managing the inventory 308 of parts A-F that are on hand and for ordering more parts A-F in order to maintain an optimal inventory 308 of parts A-F. An optimal inventory 308 of parts A-F requires having a sufficient number of parts A-F to meet near term production demands while minimizing surplus inventory 308 to reduce holding costs. A shortage of inventory 308 for parts A-F refers to having an insufficient quantity of that part A-F to meet the current production demands and safety stock levels for unexpected disruptions to near term production. Surplus inventory 308 refers to a facility 306 having a quantity of a part A-F which exceeds the current production needs and safety stock levels for unexpected disruptions to near term production.

Surplus inventory 308 can tie up capital, increase storage costs, and increase the risk of deterioration to the part, making it important for companies to manage and optimize inventory 308 levels effectively. Current and near-term production demands can vary across the different facilities 306 of the company 304. Thus, each planner must forecast production demand of the facility 306 accurately, considering factors such as production schedules, lead times, and supplier reliability. Again, the method disclosed above may be utilized to determine these levels.

Inventory data 312 is shared between planners at each facility 306 through system 300. The marketplace system 300 identifies potential shortages or surpluses of parts A-F at each facility 306 and the proposes reallocation of parts A-F to balance inventory 308 across the different facilities 306 of the company 304. This enables planners at each facility 306 of the company 304 to view inventory 308 at other facilities 306, as well as other relevant supply chain data like external supplier 310 orders and gross demand. Further, the marketplace system 300 matches one facility's needs (gross demand of parts) with another facility's inventory 308 and future supplier 310 orders.

The marketplace system 300 as described herein is used in context of a company 304 that manufactures components out of parts; however, the marketplace system 300 is suitable to balance inventory 308 at other companies that involve supplying parts or goods.

The marketplace system 300 is hosted on a computer server that includes means for processing real-time inventory data 312 of the company 304 and electronically communicates that information to client devices through the internet. As an example, computer control 104 of FIG. 1A may be used. Existing inventory data 312 for each facility can be directly uploaded to the marketplace system 300 by the planner responsible for that facility, or the marketplace system 300 may be configured to electronically communicate with a separate system that logs inventory 308 for each facility 306 of the company 304. Such inventory data 312 may include, for example, at least current stock levels, safety stock levels, days on hand, shipping time, orders, projected orders, and production schedules.

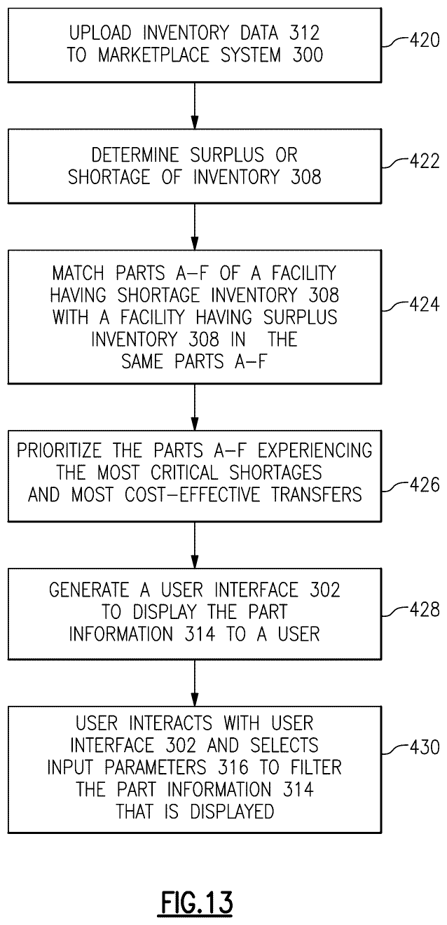

A disclosed method is in FIG. 13, and includes a first step 420 of uploading the inventory data 312 to the marketplace system 300 and continuously updating the inventory data 312 in the marketplace system 300. The marketplace system 300 performs a second step 422 and determines the excess or a shortage of inventory 308 for each part A-F at each of the facilities 306 based on the inventory data 312. Next, the marketplace system 300 performs a third, matching step 424. This involves matching parts A-F of facilities 306 having a shortage with facilities 306 having surplus inventory 308 in the same part A-F. The matching step further includes determining whether the facility 306 should order parts A-F from another facility 306 in the company 306 or from an external supplier 310. After the matching step 424 the marketplace system 300 performs a fourth, optimization step 426 that includes prioritizing the most critical shortages and the most cost-effective transfers. In a fifth step 428, the marketplace system 300 generates user interfaces 302 to display part information 314 that is derived from the inventory data 312. Finally, in a sixth step 430, the planner interacts with the user interface 302 by selecting input parameters 316 which causes the marketplace system 300 to filter the part information 314 that is displayed in the user interface 302 according to the selected input parameters 316.

At least some of the surplus parts at one facility may then be shipped to the facility with the shortage.

The user interfaces 302 shown in FIG. 11 and FIG. 12 include input parameters 316 through which the planner may interact with the marketplace system 300 and filter the part information 314.

FIG. 11 shows a display for 302a and FIG. 12 shows a display for 302b. These may be for facilities 306A and 306B. More specifically, the input parameters 316 are used by the planner to filter the part information 314 so that the user interface 302 displays only certain part information 314. For example, the part information 314 can be filtered so that the user interface 302 only displays part information 314 for one part A-F, parts A-F from a specific facility 306, etc. The input parameters 316 may include facility tabs 330a-n, a sell tab 332, a buy tab 333, an item search bar 334, a trading facility filter 336. Additionally, the user interface 302 includes a date 338 and is further configured to display the part information 314 in a table 340. The part information 314 displayed may be filtered based on the selections made by the planner in one or more of the facility tabs 330a-n, sell tab 332, buy tab 333, search bar 334, and trading facility filter 336. The facility tabs 330a-n include a tab for each facility 306 of the company 304. It is understood that any number of tabs 330a-n may be provided to accommodate the number of facilities 306 of a company 304. Of course, in practice, a company 304 may include hundreds of facilities 306. Thus, in other embodiments, the tabs 330a-n may be replaced or supplemented by a search bar, drop down menu, or other comparable format.

The planner selects one of the facility tabs 330a-n and in response, the processor analyzes and the user interface 302 displays part information 314 with respect to that facility 306. The search bar 334 enables the planner to filter the part information 314 that is displayed in the table 340 to only include a specific part A-F. If the planner does not specify a part A-F in the search bar, the default setting of the processor returns part information 314 for each part A-F of the selected facility 306A that has shortage or surplus inventory 308.

The trading facility filter 336 enables the planner to filter the part information 314 displayed in the table 340 to only include parts A-F from a specific trading facility 306B. If the planner does not select a trading facility 306B in the trading facility filter 336, the default setting of the processor returns part information 314 for any trading facility 306B within the company 304 that meets the demand or supply needs of the selected facility 306A.

The marketplace system 300 prompts the planner to select either the sell tab 332 or the buy tab 333. FIG. 11 represents a user interface 302a of the marketplace system 300 corresponding to a selection of the sell tab 332. Selecting the sell tab 332 instructs the marketplace system 300 to filter parts A-F having surplus inventory 308 at the selected facility 306A. Further, the marketplace system 300 identifies trading facilities 306B that are experiencing an inventory 308 shortage in the same parts A-F. One or more trading facilities 306B may be identified for each part A-F. Then, the parts A-F of the selected facility 306A having a surplus inventory 308 are matched with the trading facilitates 306B experiencing an inventory 308 shortage in the same part A-F and displays the part information 314 in the table 340. This optimizes the matching process by prioritizing the most critical shortages and the most cost-effective transfers.

As shown in FIG. 11, the inventory data 312 is analyzed and table 340 is produced containing the part information 314.

The part information 314 displayed within the table 340 of the user interface 302a associated with selection of the sell tab 332 may include the following: a unique part number 342a corresponding to the part A-F with surplus inventory 308 at the selected facility 306A, days on hand 344a of that part A-F at the selected facility 306A, demand 346a for the part A-F at the selected facility 306A, orders 348a for the part A-F at the selected facility, total number of parts 350a at the selected facility, the matched trading facility 352a, a unique part number 354a of the part A-F at the trading facility 306B, the days on hand 356a of the part A-F at the trading facility 306B, the demand 358a for the part A-F at the trading facility 306B, trading orders 360a, parts A-F to be sold 362a, and total value 364a of each individual part A-F to be sold. Lastly, the marketplace system 300 calculates a total value of all parts A-F available to be sold by the selected facility 306A and matched with a trading facility 306B and includes a total number of parts 366a and sum total 368a the value of those parts A-F at the bottom of the table 340.

FIG. 12 represents the user interface 302b corresponding to a selection of the buy tab 333. Selecting the buy tab 333 instructs the marketplace system 300 to identify parts A-F that are in short supply at the selected facility 306A. Trading facilities 306B having surplus inventory 308 of the same parts A-F are identified. One or more trading facilities 306B may be identified for each part A-F. The selected facility 306A are then matched with the trading facility 306B and the part information 314 is displayed in the table 340. The matching process is optimized by prioritizing the most critical shortages and the most cost-effective transfers. As shown in FIG. 11, the inventory data 312 is analyzed and a table 340 is produced with the part information 314. The part information 314 included within the table 340 may be selected from the following: a unique part number 342b corresponding to the part A-F having an inventory 308 shortage at the selected facility 306A, days on hand 344a of that part A-F at the selected facility 306A, six month demand 346b for the part A-F at the selected facility 306A, planned orders 348b for the part A-F at the selected facility 306A, total number 350b of parts A-F at the selected facility 306A, the matched trading facility 52b, the unique part number 354b of the part A-F at the trading facility 306B, the days on hand 356b of the part A-F at the trading facility 306B, six month trade demand 358b for the part A-F at the trading facility 306B, net trade pieces 361b, number of parts 362b available to be purchased from the trading facility 306B, and total value 364b of each individual part A-F to be purchased from the trading facility 306B. Lastly, the processor calculates a total sum 365b of the trade pieces of all parts A-F, a total value 368b of all parts A-F available to be bought by the selected facility 306A and a total number 366b of parts A-F to be bought and each of these values is included in the table 340.

The aspects descripted in FIGS. 10-13 are disclosed in co-pending U.S. Provisional Patent Application No. ______, filed on even date herewith entitled “METHOD AND SYSTEM FOR MANAGING PART INVENTORY BETWEEN RELATED FACILITIES” and owned by the applicant here.

An apparatus under this disclosure could be said to include at least one processor and at least one memory in electronic communication with at least one processor. The at least one memory has instruction stored thereon which when executed by the at least one processor direct the at least one processor to communicate to a communication device of at least one user to display a minimum safety factor of parts on hand which is determined based upon a usage of each of a plurality of parts within a predetermined period of time. A display device is communicated to provide the minimum safety factor on the display device.

A factory under this disclosure could be said to include machinery for forming components. The factory includes a plurality of parts on hand. A computer comprising at least one processor and at least one memory in electronic communication with at least one processor. The at least one memory has instruction stored thereon which when executed by the at least one processor direct the at least one processor to communicate to a communication device of at least one user to display a safety factor of parts on hand which is determined based upon a usage of each of a plurality of parts within a predetermined period of time. A display device is communicated to to provide the minimum safety factor on the display device.

A method under this disclosure could be said to include determining a minimum safety factor of a plurality parts on hand based upon a usage of each of a plurality of parts within a predetermined period of time and displaying the minimum safety factor on a display device.

Although embodiments of this disclosure have been shown, a worker of ordinary skill in this art would recognize that modifications would come within the scope of this disclosure. For that reason, the following claims should be studied to determine the true scope and content of this disclosure.

What is claimed is:

1. An apparatus comprising:
at least one processor;
at least one memory in electronic communication with at least one processor, the at least one memory having instruction stored thereon which when executed by the at least one processor direct the at least one processor to communicate to a communication device of at least one user to display a minimum safety factor of parts on hand which is determined based upon a usage of each of a plurality of parts within a predetermined period of time; and
to communicate to a display device to provide the minimum safety factor on the display device.

2. The apparatus of claim 1, wherein the minimum safety factor is utilized in combination with other factors to determine whether there is excess inventory of the particular part.

3. The apparatus of claim 1, wherein the memory having instructions that identify each of the plurality of parts with a class level, with the highest class level being based upon relatively high price and relatively high use of the particular part, and a lowest class level being determined based upon relatively low cost and relatively low use, and to display an identified class on the display associated with each of the plurality of parts.

4. The apparatus of claim 3, wherein the highest class level is ordered from a supplier more frequently than the lowest class level.

5. The apparatus of claim 4, wherein the predetermined period of time is an average daily usage is used to determine said minimum safety factors at least in part.

6. The apparatus of claim 4, wherein the minimum safety factors are means of the average daily usage across a predetermined period of time and utilizing a particular number of work days.

7. The apparatus of claim 6, wherein the average daily usage is determined across a plurality of weeks, and the demand in a first half is compared to a demand in the second half and if the demand in the second half is less than or equal to the demand in the first half by more than a predetermined amount, then a normalized demand is utilized for the average daily usage which is selected to be a number of standard deviations away from a mean.

8. A factory comprising:
machinery for forming components;
the factory including a plurality of parts on hand:
a computer comprising;
at least one processor;
at least one memory in electronic communication with at least one processor, the at least one memory having instruction stored thereon which when executed by the at least one processor direct the at least one processor to communicate to a communication device of at least one user to display a safety factor of parts on hand which is determined based upon a usage of each of a plurality of parts within a predetermined period of time; and
to communicate to a display device to provide the minimum safety factor on the display device.

9. The factory of claim 8, wherein the minimum safety factor is utilized in combination with other factors to determine whether there is excess inventory of the particular part.

10. The factory of claim 8, wherein the memory having instructions that identify each of the plurality of parts with a class level, with the highest class level being based upon relatively high price and relatively high use of the particular part, and a lowest class level being determined based upon relatively low cost and relatively low use, and to display an identified class on the display associated with each of the plurality of parts.

11. The factory of claim 10, wherein the highest class level is ordered from a supplier more frequently than the lowest class level.

12. The factory of claim 11, wherein the predetermined period of time is an average daily usage is used to determine said safety factors at least in part.

13. The apparatus as set forth in claim 11, wherein the minimum safety factors are means of the average daily usage across a predetermined period of time and utilizing a particular number of work days.

14. The apparatus as set forth in claim 13, wherein the average daily usage is determined across a plurality of weeks, and the demand in a first half is compared to a demand in the second half and if the demand in the second half is less than or equal to the demand in the first half by more than a predetermined amount, then a normalized demand is utilized for the average daily usage which is selected to be a number of standard deviations away from a mean.

15. A method comprising:
determining a minimum safety factor of a plurality parts on hand based upon a usage of each of a plurality of parts within a predetermined period of time; and
displaying the minimum safety factor on a display device.

16. The method of claim 15, wherein the minimum safety factor is utilized in combination with other factors to determine whether there is excess inventory of the particular part.

17. The method of claim 15, further including the step of identifying each of the plurality of parts with a class level, with the highest class level being based upon relatively high price and relatively high use of the particular part, and a lowest class level being determined based upon relatively low cost and relatively low use, and displaying an identified class associated with each of the plurality of parts.

18. The method of claim 17, wherein ordering the highest class level parts from a supplier more frequently than the lowest class level.

19. The method of claim 18, wherein the predetermined period of time is an average daily usage to determine said minimum safety factors.

20. The method of claim 18, wherein the minimum safety factors are means of the average daily usage across a predetermined period of time and utilizing a particular number of work days.

21. The method of claim 20, wherein the average daily usage is determined across a plurality of weeks, and the demand in a first half is compared to a demand in the second half and if the demand in the second half is less than or equal to the demand in the first half by more than a predetermined amount, then a normalized demand is utilized for the average daily usage which is selected to be a number of standard deviations away from a mean.
